(19) United States
(12) Patent Application Publication
(10) Pub. No.: US 2025/0391393 A1
(43) Pub. Date: Dec. 25, 2025

(54) RESONATOR

(71) Applicants: TOYOTA JIDOSHA KABUSHIKI KAISHA, Toyota-shi Aichi-ken (JP); TOYOTSU AUTOMOTIVE CREATION CORPORATION, Nakamura-ku Nagoya-shi Aichi (JP); Excell Corporation, Matsudo City Chiba Prefecture (JP)

(72) Inventors: Keisuke ITOH, Aichi-gun Aichi-ken (JP); Akira KINOSHITA, Toyota-shi Aichi-ken (JP); Yuho FURUMORI, Nisshin-shi Aichi-ken (JP); Yoshinori OOSAWA, Kiryu-shi Gunma-ken (JP)

(73) Assignees: TOYOTA JIDOSHA KABUSHIKI KAISHA, Toyota-shi Aichi-ken (JP); TOYOTSU AUTOMOTIVE CREATION CORPORATION, Nakamura-ku Nagoya-shi Aichi (JP); Excell Corporation, Matsudo City Chiba Prefecture (JP)

(21) Appl. No.: 19/184,533

(22) Filed: Apr. 21, 2025

(30) Foreign Application Priority Data
Jun. 20, 2024 (JP) 2024-099886

(51) Int. Cl. G10K 11/172; B60B 21/12

(52) U.S. Cl. CPC G10K 11/172; B60B 21/12; B60B 2900/133

(57) ABSTRACT

A resonator includes one tubular portion having a hairpin-bend shape on a substrate having a rectangular shape. First to third straight portions adjacent in the tubular portion are coupled to each other by ribs at positions in the directions of the central axes thereof. According to the configuration, it is possible to set the rigidity and the flexibility of the resonator in a well-balanced manner such as making it possible to moderately set the rigidity of the resonator to make the resonator more difficult to elastically deform than a resonator in which the first to third straight portions are not coupled to each other, and making it possible to moderately set the flexibility of the resonator to make the resonator easier to elastically deform than a resonator in which the whole regions of the first to third straight portions in the directions of the respective central axes thereof are coupled.

### CROSS-REFERENCE TO RELATED APPLICATION

This application claims priority to Japanese Patent Application No. 2024-099886 filed on Jun. 20, 2024, incorporated herein by reference in its entirety.

### BACKGROUND

### 1. Technical Field

The present disclosure relates to a resonator.

### 2. Description of Related Art

For example, paragraph 0017 of WO 2020/157907 describes “the resonator 1 is shaped such that one end thereof is folded back toward the other end thereof, and has two portions 11, 12 that extend in parallel to each other and a portion 13 that connects the two portions. The length L1 of the portion 11 is longer than the length L2 of the portion 12. The length L3 of the portion 13 is shorter than the length L2 of the portion 12.”.

### SUMMARY

WO 2020/157907 has a concern about rigidity decreased by the U-shaped resonator 1.

In view of such circumstances, an object of the present disclosure is to provide a resonator made easier to attach to a wheel and then made more difficult to detach from the wheel.

The present disclosure is a resonator including one tubular portion provide on a substrate. The substrate has a rectangular shape. The tubular portion has a hairpin-bend shape. A plurality of straight portions is coupled to each other by ribs in the tubular portion at a plurality of positions in the directions of the central axes of the straight portions. The straight portions are disposed side by side in parallel.

According to the configuration, it is possible to moderately set the rigidity of the resonator to make the resonator more difficult to elastically deform, for example, than a resonator in which the straight portions are not coupled to each other. In addition, it is possible to moderately set the flexibility of the resonator to make the resonator easier to elastically deform, for example, than a resonator in which the whole regions of the straight portions in the directions of the respective central axes of the straight portions are coupled.

As described above, it is possible to set the rigidity and the flexibility of the resonator in a well-balanced manner. For example, in a case where the resonator is attached to a wheel for a vehicle, it is thus easier to attach the resonator because the resonator is moderately easy to elastically deform. Meanwhile, the resonator is moderately difficult to deform when receiving the rotational centrifugal force of the wheel. The resonator is therefore more difficult to detach from the wheel.

As described above, the resonator according to the present disclosure allows for easier attachment to a wheel and then allows for more difficult detachment from the wheel.

It is, however, possible to adopt, in the resonator, a configuration in which the central axis of each of the straight portions is parallel with a first side and a second side of four sides of the substrate. The first side and the second side face each other. An opening of the tubular portion at an end of the tubular portion in the direction of the central axis of the tubular portion is disposed on one of a third side and a fourth side of the substrate. The third side and the fourth side are orthogonal to the first side. An opening of the tubular portion at the other end of the tubular portion in the direction of the central axis of the tubular portion is disposed on the other of the third side and the fourth side.

In addition, it is possible to adopt, in the resonator, a configuration in which the straight portions include three straight portions. The central axis of each of the straight portions is parallel with a first side and a second side of four sides of the substrate. The first side and the second side face each other. An end of each of the straight portions in the direction of the central axis of the straight portion is disposed on one of a third side and a fourth side of the substrate and the other end of each of the straight portions in the direction of the central axis of the straight portion is disposed on the other of the third side and the fourth side. The third side and the fourth side are orthogonal to the first side. An end of a first straight portion located at the left end and the other end of a third straight portion located at the right end are open. The other end of the first straight portion and the other end of a second straight portion located in the middle are coupled by a first U-shaped portion. An end of the second straight portion and an end of the third straight portion located at the right end are coupled by a second U-shaped portion.

According to the configuration, the ceiling surfaces of the respective inner holes of the first straight portion and the third straight portion are inclined surfaces each having a rising gradient from the end thereof to the other end thereof, and the ceiling surface of the inner hole of the second straight portion is an inclined surface having a rising gradient from the other end thereof to the end thereof.

Thus, even if liquid, such as a puncture repair agent or water, flows into the first straight portion from the opening of the first straight portion at the end thereof in a case where a target to which the resonator is attached is, for example, a wheel for a vehicle, centrifugal force generated along with the rotation of the wheel causes the liquid flowing into the first straight portion to flow on the ceiling surface of the inner hole of the first straight portion to the second straight portion and then flow on the ceiling surface of the inner hole of the second straight portion to the third straight portion. The liquid is eventually discharged from the opening of the third straight portion at the other end thereof.

As described above, it is possible to prevent the liquid from remaining in the straight portions. It is thus possible to prevent an effect of improving the NV performance by the resonator (an effect of reducing the air column resonance in the air chamber between the wheel and the tire) from worsening.

In addition, it is possible to adopt, in the resonator, a configuration in which the sectional heights of the respective inner holes of the first straight portion and the third straight portion are set to gradually increase from the ends of the first straight portion and the third straight portion to the other ends of the first straight portion and the third straight portion. The sectional height of the inner hole of the second straight portion is set to gradually increase from the other end of the second straight portion to the end of the second straight portion.

Furthermore, it is possible to adopt, in the resonator, a configuration in which the sectional heights of the respective inner holes of the first straight portion and the third straight portion are set to gradually increase from the other ends of the first straight portion and the third straight portion to the ends of the first straight portion and the third straight portion. The sectional height of the inner hole of the second straight portion is set to gradually increase from the end of the second straight portion to the other end of the second straight portion.

According to the configuration, the ceiling surfaces of the respective inner holes of the first straight portion and the third straight portion are inclined surfaces each having a rising gradient from the other end thereof to the end thereof. In addition, the ceiling surface of the inner hole of the second straight portion is an inclined surface having a rising gradient from the end thereof to the other end thereof.

Thus, even if liquid, such as a puncture repair agent or water, flows into the third straight portion from the opening of the third straight portion at the other end thereof in a case where a target to which the resonator is attached is, for example, a wheel for a vehicle, centrifugal force generated along with the rotation of the wheel causes the liquid flowing into the third straight portion to flow on the ceiling surface of the inner hole of the third straight portion to the second straight portion and then flow on the ceiling surface of the inner hole of the second straight portion to the first straight portion. The liquid is eventually discharged from the opening of the first straight portion at the other end thereof.

As described above, it is possible to prevent the liquid from remaining in the straight portions. It is thus possible to prevent an effect of improving the NV performance by the resonator (an effect of reducing the air column resonance in the air chamber between the wheel and the tire) from worsening.

According to the present disclosure, it is possible to provide a resonator made easier to attach to a wheel and then made more difficult to detach from the wheel.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view illustrating that a resonator according to the present disclosure has not yet been attached to a wheel in an embodiment of the resonator;

FIG. 2 is a perspective view illustrating that the resonator has been attached to the wheel;

FIG. 3 is a side view of the wheel in FIG. 2;

FIG. 4 is a front view of the resonator;

FIG. 5 is a rear view of the resonator;

FIG. 6A is a sectional view taken along a line (A)-(A) in FIG. 3;

FIG. 6B is a sectional view taken along a line (B)-(B) in FIG. 3;

FIG. 6C is a sectional view taken along a line (C)-(C) in FIG. 3; and

FIG. 6D is a sectional view taken along a line (D)-(D) in FIG. 3.

### DETAILED DESCRIPTION OF EMBODIMENTS

Hereinafter, the best embodiment to carry out the present disclosure will be described in detail with reference to the appended drawings.

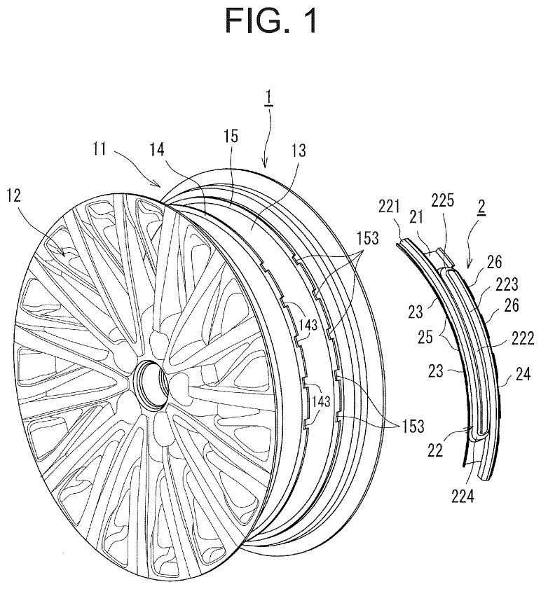

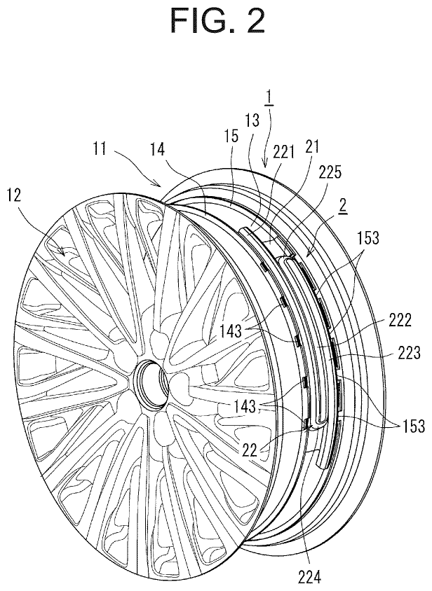

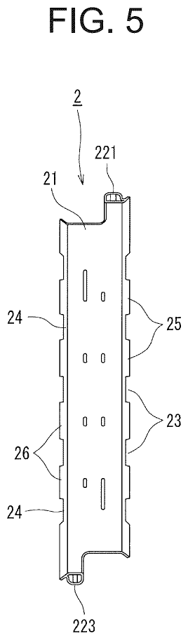

FIG. 1 to FIG. 6D each illustrate an embodiment of the present disclosure. The diagrams each disclose a resonator 2 that is attached to a wheel 1 for a vehicle.

The wheel 1 includes a rim 11 into which an unillustrated tire is fitted and a disk 12 that couples the wheel 1 to an unillustrated hub of the vehicle. The wheel 1 is formed by using metal, such as aluminum alloy or magnesium alloy.

Vertical walls 14, 15 are provided at two positions spaced apart in the width direction at a predetermined interval on the outer peripheral surface of a well portion 13 of the rim 11 such that the vertical walls 14, 15 rise radially outward and are continuous in the circumferential direction. 20

It is to be noted that the vertical wall 14 and the vertical wall 15 are both shaped like rails. Here, the vertical wall 14 located closer to the disk 12 of the wheel 1 will be referred to as the “outer vertical wall 14” and the vertical wall 15 located closer to the inner surface of the wheel 1 will be referred to as the “inner vertical wall 15”.

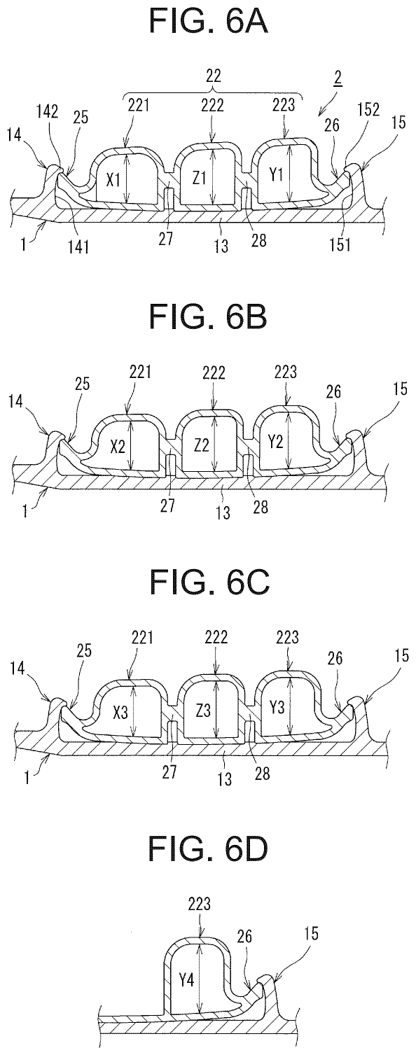

As illustrated in FIG. 6A, FIG. 6B, FIG. 6C, and FIG. 6D, the inner surfaces of the outer vertical wall 14 and the inner vertical wall 15 are respectively provided with groove portions 141, 151 in the wheel 1.

The groove portions 141, 151 are provided to cause the upper end of the inner surface of the outer vertical wall 14 and the upper end of the inner surface of the inner vertical wall 15 to respectively include protruding portions 142, 152 that protrude toward each other.

It is to be noted that a plurality of notches 143, 153 is provided in a plurality of predetermined angle regions of the outer vertical wall 14 and the inner vertical wall 15 in the embodiment such that the notches 143, 153 are spaced apart at even intervals in the circumferential direction. The resonators 2 are attached to the predetermined angle regions.

The resonators 2 are each used to reduce air column resonance in an air chamber formed between the wheel 1 and the tire (not illustrated). The resonators 2 are attached at a plurality of positions at even intervals in the circumferential direction on the outer peripheral surface of the well portion 13 of the rim 11 of the wheel 1.

It is to be noted that the resonators 2 are provided at a plurality of attachment positions at even intervals in the circumferential direction, such as two attachment positions facing each other at 180 degrees in the circumferential direction of the wheel 1, three attachment positions provided per 120 degrees in the circumferential direction of the wheel 1, or four attachment positions provided per 90 degrees in the circumferential direction of the wheel 1.

The resonators 2 each include one tubular portion 22 provided on the substrate 21. The material of each of the resonators 2 is, for example, a synthetic resin, but the material is not limited in particular.

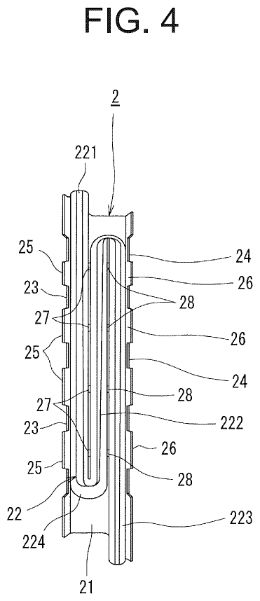

The substrate 21 is formed in a rectangular shape in plan view and a curved shape like a letter C in side view. As illustrated in FIG. 4, notches 23, 24 are provided at a plurality of positions on the long side (referred to as a first side) located on the left side of the substrate 21 in the long-side direction and a plurality of positions on the long side (referred to as a second side) located on the right side of the substrate 21 in the long-side direction such that the notches 23, 24 are spaced apart at even intervals.

There are projections 25, 26 each having a rectangular shape in plan view between the notches 23, 24, respectively. As described below, the projections 25, 26 are latched in the groove portions 141, 151 of the wheel 1.

As illustrated in FIG. 6A, FIG. 6B, FIG. 6C, and FIG. 6D, the right and left projections 26, 25 are each shaped to be inclined obliquely upward in the projecting direction thereof.

The respective intervals between the right and left notches 24, 23 are set to be greater than the intervals between the respective notches 153 of the inner vertical wall 15 of the wheel 1 and the intervals between the respective notches 143 of the outer vertical wall 14.

The tubular portion 22 has a hairpin-bend shape. Specifically, the tubular portion 22 has a shape obtained by making U-turns in the one tubular portion 22 at two positions spaced apart along the direction of the central axis thereof.

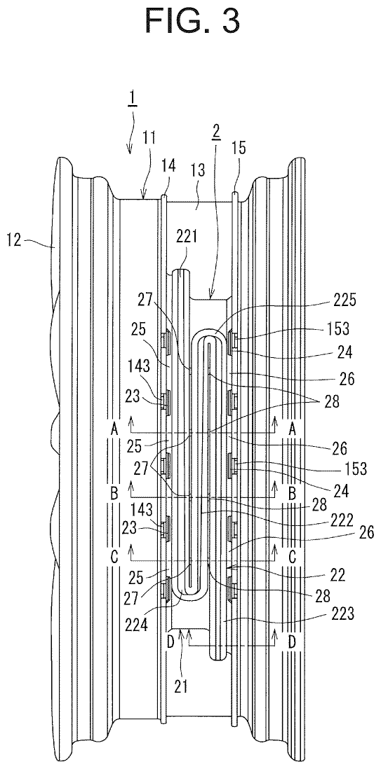

More specifically, the tubular portion 22 includes a first straight portion 221 (the left end in FIG. 3 and FIG. 4), a second straight portion 222 (the middle in FIG. 3 and FIG. 4), a third straight portion 223 (the right end in FIG. 3 and FIG. 4), a first U-shaped portion 224 (the lower side in FIG. 3 and FIG. 4), a second U-shaped portion 225 (the upper side in FIG. 3 and FIG. 4), and the like.

The first to third straight portions 221 to 223 are disposed such that the central axes thereof are parallel with the first side on the left of the substrate 21 and the second side on the right of the substrate 21. The first to third straight portions 221 to 223 are disposed side by side in parallel in the short-side direction of the substrate 21.

An end (the upper end in FIG. 3 and FIG. 4) of each of the first to third straight portions 221 to 223 in the direction of the central axis thereof is disposed on the upper short side (referred to as a third side) of the substrate 21 located at the end (the upper end in FIG. 3 and FIG. 4) of the substrate 21 in the long-side direction thereof. In addition, the other end (the lower end in FIG. 3 and FIG. 4) of each of the first to third straight portions 221 to 223 in the direction of the central axis thereof is disposed on the lower short side (referred to as a fourth side) of the substrate 21 located at the other end (the lower end in FIG. 3 and FIG. 4) of the substrate 21 in the long-side direction thereof.

Both ends of the tubular portion 22 in the direction of the central axis thereof are open. Specifically, the end (the upper end in FIG. 3 and FIG. 4) of the first straight portion in the direction of the central axis thereof is open on the third side of the substrate 21. The other end (the lower end in FIG. 3 and FIG. 4) of the third straight portion 223 in the direction of the central axis thereof is open on the fourth side of the substrate 21.

Additionally, when the rotation direction of the wheel 1 is set, for example, to the direction of an arrow in FIG. 3, the opening of the first straight portion 221 at the end thereof serves as the upstream side of the wheel 1 in the rotation direction thereof and the opening of the third straight portion 223 at the other end thereof serves as the downstream side of the wheel 1 in the rotation direction thereof.

The other end of the first straight portion 221 in the direction of the central axis thereof and the other end of the second straight portion 222 in the direction of the central axis thereof are coupled at the first U-shaped portion 224, and the end of the second straight portion 222 and the end of the third straight portion 223 are coupled at the second U-shaped portion 225.

As illustrated in FIG. 4, FIG. 6A, FIG. 6B, FIG. 6C, and FIG. 6D, the first straight portion 221 and the second straight portion 222 are then coupled by ribs 27 at a plurality of positions at even intervals in the directions of the central axes thereof, and the second straight portion 222 and the third straight portion 223 are coupled by ribs 28 at a plurality of positions at even intervals in the directions of the central axes thereof.

Furthermore, the sectional heights of the respective inner holes of the first straight portion 221 and the third straight portion 223 are each set to gradually increase from the end (the third side of the substrate 21) thereof to the other end (the fourth side of the substrate 21) thereof in the direction of the central axis thereof, and the sectional height of the inner hole of the second straight portion 222 is set to gradually increase from the other end (the fourth side of the substrate 21) thereof to the end (the third side of the substrate 21) thereof in the direction of the central axis thereof.

That is, when the sectional heights of the respective inner holes of the first straight portion 221 and the third straight portion 223 illustrated in FIG. 6A are denoted by X1, Y1, the sectional heights illustrated in FIG. 6B are denoted by X2, Y2, the sectional heights illustrated in FIG. 6C are denoted by X3, Y3, and the sectional height of the inner hole of the third straight portion 223 illustrated in FIG. 6D is denoted by Y4, relationships of X1<X2<X3 and Y1<Y2<Y3<Y4 are set.

In addition, when the sectional height of the inner hole of the second straight portion 222 illustrated in FIG. 6A is denoted by Z1, the sectional height illustrated in FIG. 6B is denoted by Z2, and the sectional height illustrated in FIG. 6C is denoted by Z3, a relationship of Z1>Z2>Z3 is set.

The ceiling surfaces of the respective inner holes of the first straight portion 221 and the third straight portion 223 are thus inclined surfaces each having a rising gradient from the end thereof to the other end thereof in the direction of the central axis thereof. In addition, the ceiling surface of the inner hole of the second straight portion 222 is an inclined surface having a rising gradient from the other end thereof to the end thereof in the direction of the central axis thereof. The gradients each have any angle.

Next, examples of a procedure and an operation of attaching the resonator 2 to the wheel 1 will be described.

The resonator 2 is fitted between the outer vertical wall 14 and the inner vertical wall 15 of the wheel 1. When the right and left projections 26, 25 of the resonator 2 are inserted to the groove portions 151, 141 of the inner vertical wall 15 and the outer vertical wall 14 while being elastically deformed one by one, the right and left projections 26, 25 are elastically restored and the tips of the projections 26, 25 in the projecting directions thereof are latched by the inner corners of the inner vertical wall 15 and the outer vertical wall 14 closer to the upper ends of the vertical walls 15, 14, that is, the protruding portions 152, 142 in the respective groove portions 151, 141 of the vertical walls 15, 14.

Moreover, the first to third straight portions 221 to 223 are coupled by the ribs 27, 28 at a plurality of positions in the directions of the central axes thereof in the resonator 2. It is thus possible to moderately set the rigidity of the resonator 2 to make the resonator 2 more difficult to elastically deform than a resonator in which the first to third straight portions 221 to 223 are not coupled to each other. In addition, it is possible to moderately set the flexibility of the resonator 2 to make the resonator 2 easier to elastically deform, for example, than a resonator in which the whole regions of the first to third straight portions 221 to 223 in the directions of the respective central axes thereof are coupled.

As described above, it is possible to set the rigidity and the flexibility of the resonator 2 in a well-balanced manner. It is thus easier to attach the resonator 2 to the wheel 1 because the resonator 2 is moderately easy to elastically deform at the time of attachment. Meanwhile, the resonator 2 is moderately difficult to elastically deform when receiving the rotational centrifugal force of the wheel 1. The right and left projections 26, 25 of the resonator 2 are therefore more difficult to detach from the groove portions 151, 141 of the wheel 1.

As described above, the resonator 2 according to the embodiment to which the present disclosure is applied allows for easier attachment to the wheel 1 and allows for more difficult detachment from the wheel 1.

Generally speaking, when the wheel 1 is increased in diameter, the unsprung weight of the vehicle increases along with the increased weight of the wheel 1 to worsen ride comfort. If the wheel 1 is reduced in weight to improve the ride comfort, the wheel 1 is reduced in rigidity to worsen the NV performance. Accordingly, it is conceivable to secure the rigidity of the wheel 1 to be increased in diameter and then attach the resonator 2 to the wheel 1 to improve the NV performance. The case has a problem of making the resonator 2 easier to attach to the wheel 1 and then making the resonator 2 more difficult to detach from the wheel 1 along with the rotation of the wheel 1, but the embodiment makes it possible to solve the problem.

Moreover, in the resonator 2 according to the embodiment, the ceiling surfaces of the respective inner holes of the first straight portion 221 and the third straight portion 223 of the tubular portion 22 are inclined surfaces each having a rising gradient from the end thereof to the other end thereof in the direction of the central axis thereof, and the ceiling surface of the inner hole of the second straight portion 222 is an inclined surface having a rising gradient from the other end thereof to the end thereof in the direction of the central axis thereof. Therefore, even if liquid, such as a puncture repair agent or water, flows into the first straight portion 221 from the opening of the first straight portion 221 at the end thereof, centrifugal force generated along with the rotation of the wheel 1 causes the liquid flowing into the first straight portion 221 to flow on the ceiling surface of the inner hole of the first straight portion 221 to the second straight portion 222 and then flow on the ceiling surface of the inner hole of the second straight portion 222 to the third straight portion 223.

The liquid is eventually discharged from the opening of the third straight portion 223 at the other end thereof.

This makes it possible to prevent the liquid from remaining in the first to third straight portions 221 to 223. It is thus possible to prevent the effect of improving the NV performance by the resonator 2 (the effect of reducing the air column resonance in the air chamber between the wheel 1 and the unillustrated tire) from worsening.

It is to be noted that the present disclosure is not limited to the embodiment alone. It is possible to change the present disclosure as appropriate within the scope of the claims and the scope equivalent to the claims.

(1) In the embodiment, it is possible to attach the resonator 2 according to the present disclosure to the wheel 1 though the wheel 1 is not provided with the notches 143, 153 of the outer vertical wall 14 and the inner vertical wall 15. Even such a case offers workings and effects equivalent to the workings and effects of the embodiment.

(2) In the embodiment, it is possible to set any dimensions for the ribs 27, 28 of the resonator 2 and any number of ribs 27, 28 of the resonator 2 along the circumferential direction.

(3) In the embodiment, it is possible to adopt a configuration in which the right and left notches 24, 23 and the projections 26, 25 of the substrate 21 of the resonator 2 are not provided. Even such a configuration offers workings and effects equivalent to the workings and effects of the embodiment.

(4) In the embodiment, it is possible to adopt a configuration in which the sectional heights of the respective inner holes of the first straight portion 221 and the third straight portion 223 are each set to gradually increase from the other end (the fourth side of the substrate 21) thereof to the end (the third side of the substrate 21) thereof, and the sectional height of the inner hole of the second straight portion 222 is set to gradually increase from the end (the third side of the substrate 21) thereof to the other end (the fourth side of the substrate 21) thereof.

The ceiling surfaces of the respective inner holes of the first straight portion 221 and the third straight portion 223 are thus inclined surfaces each having a rising gradient from the other end thereof to the end thereof. In addition, the ceiling surface of the inner hole of the second straight portion 222 is an inclined surface having a rising gradient from the end thereof to the other end thereof. The gradients each have any angle.

In such a configuration, even if liquid, such as a puncture repair agent or water, flows into the third straight portion 223 from the opening of the third straight portion 223 at the other end thereof, centrifugal force generated along with the rotation of the wheel 1 causes the liquid flowing into the third straight portion 223 to flow on the ceiling surface of the inner hole of the third straight portion 223 to the second straight portion 222 and then flow on the ceiling surface of the inner hole of the second straight portion 222 to the first straight portion 221. The liquid is eventually discharged from the opening of the first straight portion 221 at the other end thereof. Even such a mode offers workings and effects that are not inferior to the workings and effects of the embodiment.

(5) In the embodiment, it is possible to set any number of straight portions and any number of U-shaped portions of the tubular portion 22 of the resonator 2.

(6) In the embodiment, it is possible to set any intervals between the respective left notches 23 of the resonator 2 and any intervals between the respective right notches 24 of the resonator 2.

(7) In the embodiment, it is possible to set any width dimensions and any projecting dimensions for the right and left projections 26, 25 of the resonator 2 along the long-side directions thereof.

In some embodiments, the present disclosure is usable for a resonator.

What is claimed is:

1. A resonator comprising one tubular portion provided on a substrate, the substrate having a rectangular shape, the tubular portion having a hairpin-bend shape, wherein
a plurality of straight portions is coupled to each other by ribs in the tubular portion at a plurality of positions in directions of central axes of the straight portions, the straight portions being disposed side by side in parallel.

2. The resonator according to claim 1, wherein
the central axis of each of the straight portions is parallel with a first side and a second side of four sides of the substrate, the first side and the second side facing each other,
an opening of the tubular portion at an end of the tubular portion in a direction of a central axis of the tubular portion is disposed on one of a third side and a fourth side of the substrate, the third side and the fourth side being orthogonal to the first side, and
an opening of the tubular portion at another end of the tubular portion in the direction of the central axis of the tubular portion is disposed on another of the third side and the fourth side.

3. The resonator according to claim 1, wherein
the straight portions include three straight portions,
the central axis of each of the straight portions is parallel with a first side and a second side of four sides of the substrate, the first side and the second side facing each other,
an end of each of the straight portions in the direction of the central axis of the straight portion is disposed on one of a third side and a fourth side of the substrate and another end of each of the straight portions in the direction of the central axis of the straight portion is disposed on another of the third side and the fourth side, the third side and the fourth side being orthogonal to the first side,
an end of a first straight portion located at a left end and another end of a third straight portion located at a right end are open,
another end of the first straight portion and another end of a second straight portion located in a middle are coupled by a first U-shaped portion, and
an end of the second straight portion and an end of the third straight portion located at the right end are coupled by a second U-shaped portion.

4. The resonator according to claim 3, wherein
sectional heights of respective inner holes of the first straight portion and the third straight portion are set to gradually increase from the ends of the first straight portion and the third straight portion to the other ends of the first straight portion and the third straight portion, and
a sectional height of an inner hole of the second straight portion is set to gradually increase from the other end of the second straight portion to the end of the second straight portion.

5. The resonator according to claim 3, wherein
sectional heights of respective inner holes of the first straight portion and the third straight portion are set to gradually increase from the other ends of the first straight portion and the third straight portion to the ends of the first straight portion and the third straight portion, and
a sectional height of an inner hole of the second straight portion is set to gradually increase from the end of the second straight portion to the other end of the second straight portion.
